(19) United States
(12) Patent Application Publication
(10) Pub. No.: US 2016/0123361 A1
(43) Pub. Date: May 5, 2016

(54) CONNECTOR

(71) Applicant: Sumitomo Wiring Systems, Ltd., Yokkaichi (JP)

(72) Inventors: Hidefumi Horiuchi, Yokkaichi (JP); Hideto Nakamura, Yokkaichi (JP)

(21) Appl. No.: 14/887,851

(22) Filed: Oct. 20, 2015

(30) Foreign Application Priority Data
Nov. 5, 2014 (JP) 2014-225295

(51) Int. Cl. F16B 2/20

(52) U.S. Cl. CPC F16B 2/20

(57) ABSTRACT

A connector includes a housing (10) connectable to a mating housing (90) and a detector (50) assembled movably between a standby position and a detection position with respect to the housing (10). The detector (50) includes a locking arm (57) and retaining portions (63) configured to regulate rattling between the two housings (10, 90) by being sandwiched in a connecting direction of the two housings (10, 90) between the two housings (10, 90) at the detection position.

### BACKGROUND

1. Field of the Invention

The present invention relates to a connector.

2. Description of the Related Art

Japanese Patent No. 4419875 discloses a female connector with a female connector housing including a lock arm and a slider (detecting member) to be assembled movably to an advanced standby position and a retracted detection position with respect to the lock arm. The slider is kept at the advanced position until the female connector housing is connected properly to a mating male connector housing and moved to the retracted position by being biased by a spring as the two connector housings are connected properly. Thus, a user knows that the two connector housings have been connected properly when the slider reaches the retracted position.

The male connector housing has a locking protrusion and the lock arm is provided with a locking hole. The locking protrusion is fit into the locking hole of the lock arm when the two connector housings are connected properly to hold the two connector housings in a separation-regulated state.

In the above case, the locking protrusion is inserted into the locking hole of the lock arm with a play in a front-back connecting direction. Thus, the properly connected connector housings may be displaced in the front-back direction and abnormal noise may be generated due to rattling.

The present invention was completed based on the above situation and aims to provide a connector capable of preventing the generation of abnormal noise.

### SUMMARY

A connector of the invention includes a housing connectable to a mating housing, and a detector assembled movably between a standby position and a detection position with respect to the housing. The detector is kept at the standby position until the housings are connected properly and is allowed to move to the detection position as the housings are connected properly. The detector includes a regulating structure configured to regulate rattling between the housings by being sandwiched in a connecting direction of the two housings between the two housings at the detection position. Thus, abnormal noise due to rattling can be prevented. Additionally, a dedicated regulating member for regulating rattling between the two housings is not needed and an increase in the number of components can be avoided.

The housing may include a resilient lock arm configured to engage a lock of the mating housing to hold the two housings in a connected state. The regulating structure may include a locking arm configured to sandwich the lock between the locking arm and the lock arm in the connecting direction. Thus, a locked state of the lock and the lock arm is maintained stably, and rattling between the two housings can be suppressed more reliably and effectively.

The locking arm regulates movement of the detector to the detection position by resiliently locking the lock arm of the housing at the standby position and allows movement of the detector to the detection position by being pushed by the lock portion and unlocked from the lock arm when the housings are connected properly. A function of regulating rattling between the two housings and a function of keeping the detector at the standby position are aggregated in the locking arm. Thus, the regulating structure does not become particularly complicate the detector.

### BRIEF DESCRIPTION OF THE DRAWINGS

FIG. 1 is a plan view showing a state where two housings are connected properly and a detector is at a detection position in a connector of an embodiment of the invention.

FIG. 2 is a section along X-X of FIG. 1.

FIG. 3 is a section along Y-Y of FIG. 1.

FIG. 4 is a section of a housing in which the detecting member is kept at a standby position.

FIG. 5 is a section showing a state where the two housings are properly connected and a locking arm of the detecting member is deflected and deformed.

### DETAILED DESCRIPTION

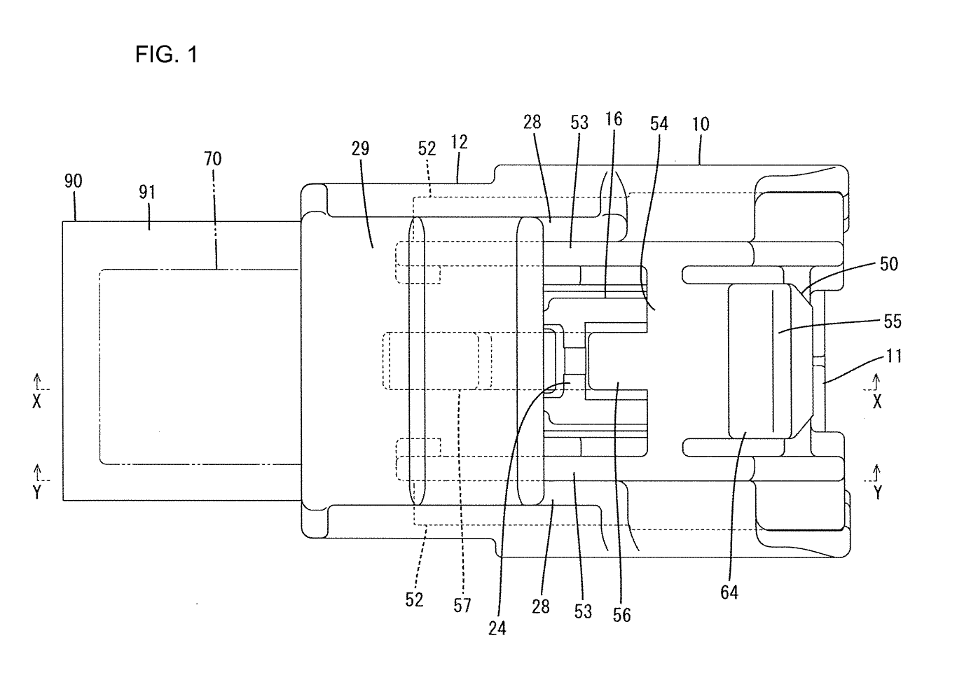

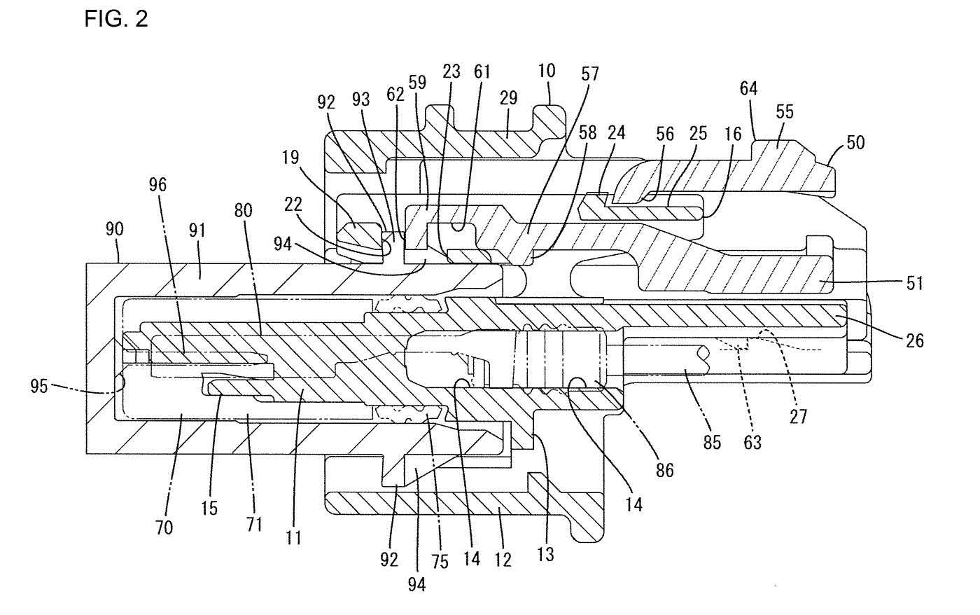

An embodiment of the invention is described with reference to FIGS. 1 to 5. A connector of this embodiment includes a housing 10 connectable to a mating housing 90, terminal fittings 80 to be accommodated into the housing 10 and a detector 50 movable to a standby position and a detection position with respect to the housing 10. Note that, in the following description, ends of the two housings 10, 90 facing each other at the start of connection are referred to as front ends concerning a front-back direction. Further, a vertical direction is based on FIGS. 2 to 5.

The male housing 90 is made of synthetic resin and is connected directly to an unillustrated device. A tubular receptacle 91 projects forward on the male housing 90, as shown in FIG. 2, and tabs 96 of mating terminal fittings 95 are arranged to project into the receptacle 91. Two locks 92 project on outer surfaces of both upper and lower walls of the receptacle 91. Each lock 92 is composed of a lock main body 93 extending along a width direction and a projecting piece 94 projecting forward from a widthwise central part of the lock main body 93. The lock main body 93 is a flat plate and both front and rear surfaces are vertical. The projecting piece 94 is triangular in a side view and has a front end sloped downward toward the front.

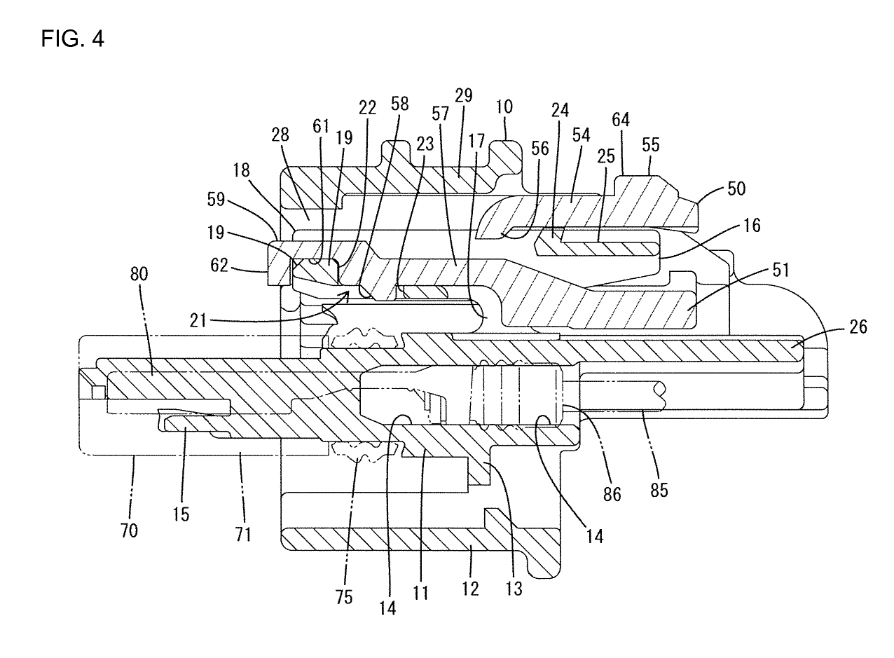

The housing 10 is made of synthetic resin and includes a housing main body 11 that is long and narrow in the front-back connecting direction, as shown in FIG. 4. A fitting tube 12 surrounds the housing main body 11, and a radially extending coupling 13 connects the fitting tube 12 and the housing main body 11. The receptacle 91 of the male housing 90 can fit into a space between the housing main body 11 and the fitting tube 12 and before the coupling 13. Cavities 14 (only one is shown) are provided in the housing main body 11, and a deflectable locking lance 15 projects forward at a position of the lower surface of an inner wall of the cavity 14 before the fitting tube 12.

As shown in FIG. 4, the terminal fitting 80 is long and narrow in the front-back direction and is inserted into the cavity 14 of the housing main body 11 from behind. The terminal fitting 80 is made of conductive metal and is retained and held in the cavity 14 by being resiliently locked by the locking lance 15. As shown in FIG. 2, the tab 96 of the mating terminal fitting 95 is inserted into the terminal fitting 80 and connected when the two housings 10, 90 are connected properly. Further, a rear end part of the terminal fitting 80 is crimped and connected to an end part of a wire 85 and a rubber plug 86. The rubber plug 86 is held in close contact with the inner peripheral surface of the cavity 14 to seal the interior of the cavity 14 in a liquid-tight manner when the terminal fitting 80 is inserted properly into the cavity 14.

As shown in FIG. 4, a front retainer 70 is mounted into the housing main body 11 from the front. The deflection of the locking lances 15 is regulated by the entrance of deflection regulating pieces 71 of the front retainer 70 into deflection spaces for the locking lances 15 so that the terminal fittings 80 are retained reliably in the cavities 14. A rubber seal ring 75 is fit externally on the outer peripheral surface of the housing main body 11. The seal ring 75 is sandwiched resiliently between the receptacle 91 and the housing main body 11 when the two housings 10, 90 are connected properly, thereby sealing between the two housings 10, 90 in a liquid-tight manner.

As shown in FIG. 4, a lock arm 16 is provided above the housing main body 11. The lock arm 16 is composed of a leg 17 that stands up from the upper surface of the housing main body 11 and an arm main body 18 that extends both forward and back from the upper end of the leg 17. The arm main body 18 includes a lock receiving portion 19 extending along the width direction on a front end part and a vertically penetrating lock hole 21 behind the lock receiving portion 19. The front end of the lock hole 21 is closed by a lock surface 22 extending along the vertical direction and open backward of the arm main body 18. The lock surface 22 is at the rear of the lock receiving portion 19. On the other hand, the rear end of the lock hole 21 is closed by a locking surface 23 located below the lock surface 22. The locking surface 23 is vertical and opens forward of the lock main body 18.

As shown in FIG. 4, a movement regulation receiving portion 24 is provided on a rear end part of the arm main body 18 and extends in the front-back direction. A rearwardly open receiving groove 25 is provided on the upper surface of the movement regulation receiving portion 24 and extends in the front-back direction. The front end of the receiving groove 25 has an inverse tapered shape protruding gradually back toward the upper end. A later-described movement regulating portion 56 of the detector 50 is insertable into the receiving groove 25 of the movement regulation receiving portion 24.

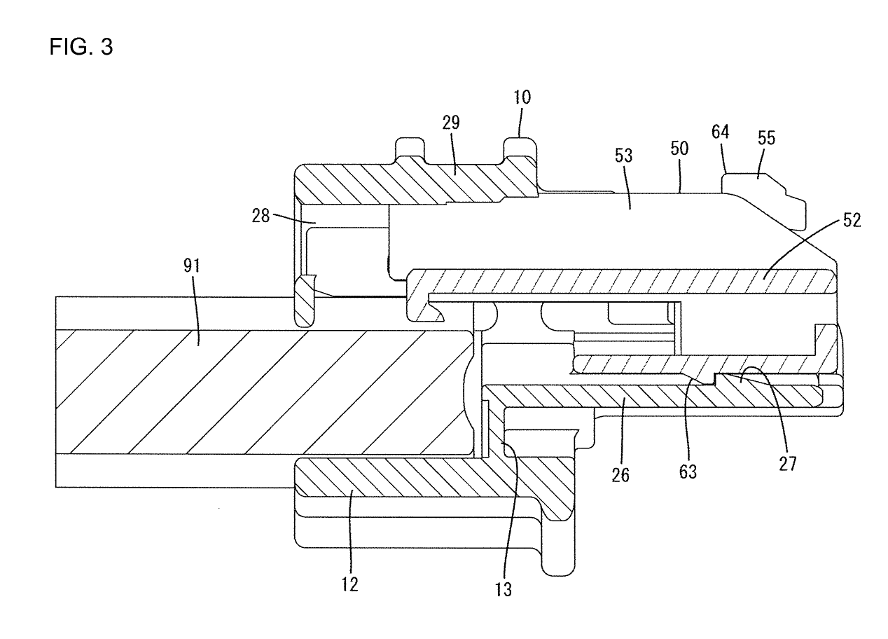

A projecting wall 26 is provided on a rear part of the housing main body 11. The projecting wall 26 is in the form of a plate extending continuously back from upper wall parts of the cavities 14. Two retaining/receiving portions 27 (one of which is shown in FIG. 3) project on opposite widthwise end parts of the upper surface of the projecting wall 26. The front ends of the retaining/receiving portions 27 are arranged along the vertical direction and can contact later-described retaining portions 63 of the detector 50.

As shown in FIG. 1, vertically aligned side walls 28 stand at opposite widthwise sides of the lock arm 16 on the top of the fitting tube 12, and a ceiling wall 29 bridges between the upper ends of both side walls 28. The side walls 28 and the ceiling wall 29 protect the lock arm 16 from external matter.

The detector 50 is made of synthetic resin and is slidable on the lock arm 16 in a space surrounded by the housing main body 11, the side walls 28 and the ceiling wall 29, as shown in FIGS. 1 and 4. The detector 50 is refracted from a standby position (see FIG. 4) with respect to the housing 10 and reaches a detection position (see FIG. 2). Additionally, the detector 50 is sandwiched between the two housings 10, 90 with loose movements in the front-back direction regulated at the detection position via a regulating structure (locking arm 57 and retaining portions 63) to be described later. Specifically, the detector 50 includes a base 51 extending along the front-back direction and the width direction. The locking arm 57 projects forward from a widthwise central part of the base 51, two spring accommodating portions 52 project forward from opposite widthwise parts of the base 51 and guides 53 stand up from the spring accommodating portions 52 and extend along the front-back direction. A bridge 54 bridges between upper ends of the guides 53 and extends along the width direction. An operating portion 55 projects back from the bridge 54 and the movement regulating portion 56 projects forward from a widthwise central part of the bridge 54.

As shown in FIG. 4, the locking arm 57 is a long and narrow rectangular column extending in the front-back direction and is deflectable and deformable in directions to move a front end part up and down with a part coupled to the base 51 as a support. A locking portion 58 projects at a position on the lower surface of the locking arm 57 near the front end. The rear surface of the locking portion 58 extends vertically. As shown in FIG. 4, when the detector 50 is at the standby position, the locking portion 58 is fit in the lock hole 21 and the rear surface of the locking portion 58 is arranged to face and lock the locking surface 23 of the arm main body 18.

A tip contact 59 is provided before the locking portion 58 on the front end part of the locking arm 57 and is substantially U-shaped in a side view, as shown in FIG. 4. The tip contact 59 includes a downwardly open recess 61. When the detector 50 is at the standby position, the lock receiving portion 19 is fit in the recess 61 of the tip contact 59 and the locking arm 57 is positioned and held on the arm main body 18.

A vertically aligned tip contact surface 62 is formed at the front of the tip contact 59. As shown in FIG. 2, the tip contact surface 62 faces and can contact the front surface of the lock main body 93 of the lock 92 when the detector 50 is at the detection position.

Springs (not shown) are accommodated in the spring accommodating portions 52 and are expandable and contractible in the front-back direction. Front and rear ends of the springs are supported in the spring accommodating portions 52. As shown in FIG. 3, the retaining portions 63 project on the lower surfaces of the spring accommodating portions 52. The rear surfaces of the retaining portions 63 are vertical and 63 and are locked to the retaining/receiving portions 27, thereby preventing the detector 50 at the detection position from coming out of the housing 10.

As shown in FIG. 1, the operating portion 55 is in the form of a wide plate substantially rectangular in a plan view and a rear part of the operating portion has an elongated projection 64 extending along the width direction. An operator can place a finger on the elongated projection 64 of the operating portion 55 for moving the detector 50 to the standby position.

As shown in FIG. 4, the movement regulating portion 56 projects straight forward from the bridge 54 and then curves down toward the front. When the operating portion 55 is pressed down, the movement regulating portion 56 is pulled up in a seesaw manner with the bridge 54 as a support. As shown in FIG. 2, the movement regulating portion 56 is in the receiving groove 25 of the movement retaining/receiving portion 24 when the detector 50 is at the detection position and the tip of the movement regulating portion 56 is arranged to be lockable to the front end of the receiving groove 25.

Prior to the connection of the two housings 10, 90, the detector 50 is inserted into the housing 10 from behind and mounted at the standby position. As shown in FIG. 4, at the standby position, the locking arm 57 is resiliently inserted in the lock hole 21 of the arm main body 18 of the lock arm 16, the locking portion 58 is arranged to contact the locking surface 23 of the arm main body 18 and the recess 61 of the tip contact 59 is fit to the lock receiving portion 19 of the arm main body 18. In this way, the detector 50 is held with movements in the front-back direction regulated at the standby position.

In the above state, the housing main body 11 of the housing 10 is fit into the receptacle 91 of the mating housing 90. In the fitting process, an inclined part of the projecting piece 94 of the lock portion 92 slides on the lock receiving portion 19 of the arm main body portion 18 and the lock arm 16 is deflected and deformed to lift the lock receiving portion 19 up. At this time, the locking arm 57 is deflected and deformed together with the lock arm 16. In the fitting process, the springs are pressed by the mating housing 90 and are compressed resiliently so that biasing forces are accumulated in the springs.

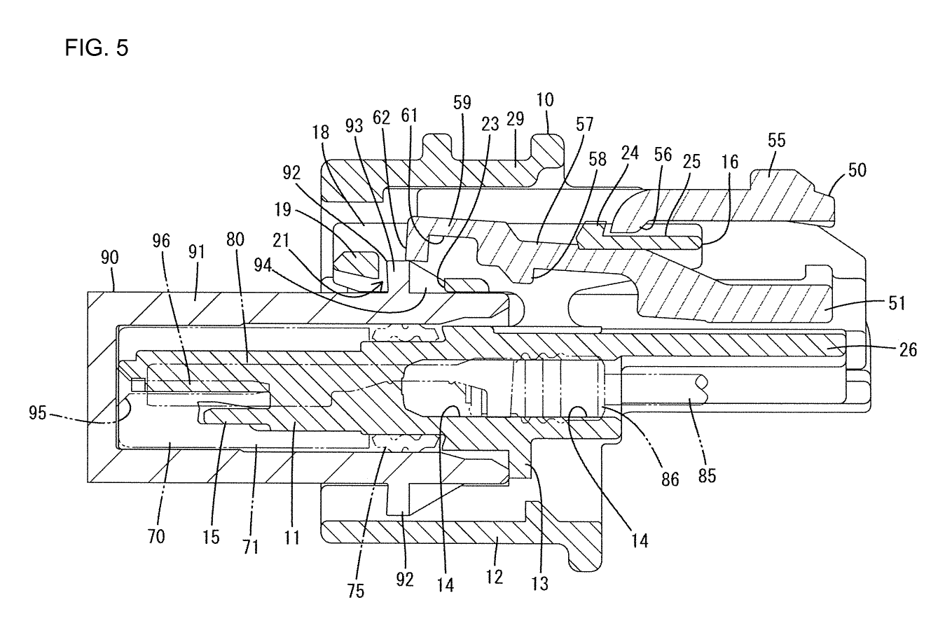

The lock arm 16 resiliently returns when the two housings 10, 90 are connected properly and the lock portion 92 is fit into the lock hole 21 from below, as shown in FIG. 5. Simultaneously, the locking arm 57 is pushed by the lock 92 to separate the tip contact portion 59 from the lock receiving portion 19 and to release locking between the locking surface 23 of the arm main body 18 and the locking portion 58. Biasing forces accumulated in the springs then are released and, as shown in FIG. 2, the detector 50 is moved automatically to the detection position. Further, the rear surface (rear surface when viewed from the mating housing 90) of the lock main body 93 contacts the lock surface 22 of the lock hole 21 by inserting the lock 92 into the lock hole 21 to hold the two housings 10, 90 in the connected state. The movement regulating portion 56 is fit resiliently into the receiving groove 25 of the movement regulation receiving portion 24 when the detector 50 reaches the detection position, thereby preventing inadvertent movement of the detector 50 to the standby position.

As shown in FIG. 5, when the lock main body 93 is fit into the lock hole 21, the tip contact 59 moves onto the lock main body 93 and the locking arm 57 is deflected and deformed. Thereafter, when the detector 50 reaches the detection position, the locking arm 57 is displaced resiliently in a return direction and the tip contact 59 moves over the lock main body 93 and descends. Further, at the detection position, the retaining portions 63 are in contact with the retaining/receiving portions 27 to regulate any further backward movement of the detector 50. Thus, when the locking arm 57 is displaced resiliently in the return direction, the tip contact portion 59 descends while sliding on the front surface (front surface when viewed from the mating housing 90) of the lock main body 93 and pushes the lock main body 93 toward the lock surface 22 of the arm main body portion 18 (see FIGS. 2 and 5). As shown in FIG. 2, when the locking arm 57 resiliently returns, the tip contact surface 62 of the tip contact 59 comes into substantially surface contact with the front surface (front surface when viewed from the mating housing 90) of the lock main body 93 so that the lock main body 93 is sandwiched between the tip contact 59 and the lock receiving portion 19. Thus, there is no clearance between the lock main body 93 and the lock receiving portion 19.

When the detector 50 is at the detection position, the tip contact 59 of the locking arm 57 is in contact with the lock main body 93 of the lock 92 and the retaining portions 63 are in contact with the retaining/receiving portions 27. Thus, the detector 50 is sandwiched in the front-back direction between the two housings 10, 90. In short, the detector 50 is arranged to strut between the two housings 10, 90. Thus, rattling due to relative displacements of the two housings 10, 90 in the front-back direction is suppressed.

According to this embodiment, when the two housings 10, 90 are connected properly and the detector 50 reaches the detection position, the detector 50 is sandwiched in the front-back direction between the two housings 10, 90 and fills up a clearance in the front-back direction between the two housings 10, 90 and to regulate rattling. Thus, it is possible to prevent abnormal noise due to rattling between the two housings 10, 90. The detector 50 suppresses rattling between the two housings 10, 90. Hence, it is not necessary to provide a dedicated rattling regulating member and an increase in the number of components can be avoided.

The lock main body 93 of the lock 92 is sandwiched between the lock receiving portion 19 of the lock arm 16 and the tip contact 59 of the locking arm 57. Thus, a locked state of the lock 92 and the lock arm 16 is maintained stably. As a result, rattling between the two housings 10, 90 can be more reliably and effectively suppressed.

A function of suppressing rattling between the two housings 10, 90 and a function of keeping the detector 50 at the standby position are aggregated in the locking arm 57. Thus, the structure of the detector 50 is simplified as compared with the case where the both functions are provided individually to different parts of the detector 50.

Other embodiments of the present invention are briefly described below.

Rattling between the two housings may be regulated by arranging parts of the detector other than the locking arm to be able to come into contact with the mating housing.

Rattling between the two housings may be regulated by arranging parts of the detector other than the retaining portions to be able to contact the mating housing.

The detector may not include any spring and may be moved manually from the standby position to the detection position with respect to the housing.

### LIST OF REFERENCE SIGNS

10 . . . housing
11 . . . housing main body
16 . . . lock arm
50 . . . detector
57 . . . locking arm (regulating structure)
63 . . . retaining portion (regulating structure)
90 . . . mating housing

What is claimed is:

1. A connector, comprising:
a housing (10) connectable to a mating housing (90); and
a detector (50) assembled movably between a standby position and a detection position with respect to the housing (10), the detector (50) being kept at the standby position until the two housings (10, 90) are connected properly and being allowed to move to the detection position as the two housings (10, 90) are connected properly, wherein the detector (50) includes a regulating structure configured to regulate rattling between the two housings (10, 90) by being sandwiched in a connecting direction of the two housings (10, 90) between the two housings (10, 90) at the detection position.

2. The connector of claim 1, wherein:
the housing (10) includes a lock arm (16) configured to hold the two housings (10, 90) in a connected state by resiliently locking a lock (92) of the mating housing (90); and
the regulating structure (57, 63) includes a locking arm (57) configured to sandwich the lock (92) between the locking arm (57) and the lock arm (16) in the connecting direction.

3. The connector of claim 2, wherein the locking arm (57) regulates a movement of the detector (50) to the detection position by resiliently locking the lock arm (16) of the housing (50) at the standby position and allows the movement of the detector (50) to the detection position by being pushed by the lock (92) and unlocked from the lock arm (16) when the two housings (10, 90) are connected properly.
